(19) United States
(12) Patent Application Publication
(10) Pub. No.: US 2015/0135581 A1
(43) Pub. Date: May 21, 2015

(54) Fishing Apparatus

(71) Applicants: Jonny Curd, London (GB); Craig Wimbledon, Surrey (GB)

(72) Inventors: Jonny Curd, London (GB); Craig Wimbledon, Surrey (GB)

(21) Appl. No.: 14/401,784

(22) PCT Filed: May 15, 2013
(86) PCT No.: PCT/GB2013/000220

§ 371 Date: Nov. 17, 2014

(30) Foreign Application Priority Data
May 17, 2012 (GB) 1208665.8

(51) Int. Cl. A01K 97/18; A01K 91/06; A01K 97/24; A01K 91/00

(52) U.S. Cl. CPC A01K 97/18; A01K 91/00; A01K 91/06; A01K 97/24
USPC 43/43.1

(57) ABSTRACT

The fishing apparatus (1) includes a body (20) and at either end of the body there is a first length (21a) and a second length (21b) of a line with hooks (23a, 23b) on respective ends. If a fish bites one of the hooks then the other hook is pulled into a receiving member (30a, 30b) so that the hook that has not been bitten is covered so the fish that is hooked will not be damaged.

### FIELD OF THE INVENTION

The present invention relates to fishing apparatus and in particular but not exclusively to fishing apparatus having a plurality of hooks to allow for catching of a plurality of fish.

### BACKGROUND OF THE INVENTION

Fishing is one of the major sports in the UK and much of this activity entails the use of a hook and line. Most game fish spend a significant portion of their lives feeding near the bottom of a body of water such as lakes and rivers and so it is necessary to use a hook and bait to catch the fish. Depending on the type of fish to be caught the fishermen put bait at varying depths in the water. For fly fishing, the bait lies towards the surface of the water to attract fish that may mistake the bait for insects on the water surface. However, for bottom feeding fish, fisherman put their bait near the bottom of the water since the likelihood of catching fish is greatly increased as game fish tend to feed in rocky or obstructed areas that afford numerous hiding places for prey for the fish. However if a person is fishing in areas with many obstructions such as rocks there is a greater risk of snagging tackle. Fishermen loose time dealing with snags on obstructions and they try to free their lures without breaking their fishing line. The effort made is usually proportional to the value of the lure at risk of loss, with expensive lures meriting considerable expenditure of time and manpower. Also in competitions having to retrieve fishing apparatus such as lures is not desirable as the time spent may mean that time is diverted from fishing. Some fishermen have proposed “snag-free” rigs but these rigs have included complex arrangements of fishhooks, floats, and sinkers, some of which are detachable when placed under great strain as when snagged.

to avoid issues with hooks being out of action when they are snagged, fishing rigs have been developed which have multiple hooks. US 20080219242 discusses the use of two hooks where a spreader has a pair of outstretched arms, each of which has an outer end with an aperture and there are two flexible attachments that are secured to the rig and which have flexible leaders with outside ends extending respectively through the apertures. A fishhook is fastened to the outside end of each one of the flexible leaders.

CA 1276787 again describes a fishing rig for live or artificial bait that has a bendable member mounted between at least two hooks, mounted with respect to a leader such that when one hook is set in a fish, the bendable member bends upon a pull of the leader and the other hook moves toward the set hook but the hooks are secured at fixed locations on the bendable member.

However the use of two hooks on one line is generally banned in most fishing clubs in the UK. This is because having two hooks attached to one line is deemed to be unsafe. It is unsafe because if one of the hooks attached to the fishing rig is taken by a fish, the hook could damage a fish on the other line, or if there is a free hook a fisherman could be injured when removing fish from a line if there is a free hook. Further a free hook could snag on the bottom of a water course or other features in the water which increases the risk of losing tackle.

An object of the invention is to provide a fishing rig of uncomplicated construction and reasonable cost that will allow for a pair of baited fishhooks to be positioned above a rocky water bottom thereby effectively preventing snag to be discussed. Furthermore, the present invention seeks to overcome the problems of the prior art by providing fishing apparatus that can allow for Multiple lines while keeping the device safe by allowing for a “loose” hook to be retracted into a safe area of the fishing apparatus. In addition the fishing apparatus is inexpensive to manufacture, and dependable in use.

### SUMMARY OF THE INVENTION

According to a first aspect of the invention there is provided fishing apparatus having a body with at least one bore with a fishing line running through said at least one bore, the fishing line having a first length to which a first hook is attached towards an end of said first length and a second length to which a second hook is attached towards an end of said second length, characterised in that the first and second lengths extend from the body at first and second locations and said first and second locations are in proximity to first and second receiving members such that if a force is applied to the first hook, the second hook can be drawn into the second receiving member and if a force is applied to the second hook the first hook can be drawn into the first receiving member.

Preferably the body is an elongate tube. The tube typically could be made of a relatively solid material such as a metal e.g. brass which will provide a degree of weight to enable the body to sink.

It is envisaged that the tube has flared ends which provide the first and second receiving members.

Preferably the receiving members are integral with the tube but they may also be a separate member that can be releasably attached to the body.

Preferably the receiving members are inserts that can be push fitted into first and second locations of the body.

In a preferred arrangement each receiving member includes a foam insert into which a hook can become embedded when it is drawn through the body.

It is envisaged that the body has anchor points to which a main fishing line can be attached to the body of the fishing apparatus.

Preferably the body has securing members to which a feeder or weight can be releasably secured.

It is envisaged that the body has attachment means to enable one body to be releasably secured to another body.

It is further envisaged that the body has a plurality of bores each with a line having a hook secured to either end of said line.

### BRIEF DESCRIPTION OF THE FIGURES

An embodiment of the invention will be described with reference to and as illustrated in the accompanying figures by way of example only, in which:

FIG. 1 shows: a side view of fishing apparatus according to an embodiment of the invention;

FIG. 2 shows: a perspective view of an end of a fishing apparatus as shown in FIG. 1;

FIG. 3 shows: fishing apparatus as shown in FIG. 1 with feeding attachments;

FIG. 4 shows: a fishing apparatus with a central attachment to a line;

FIG. 5 shows: a plan view of a fishing apparatus that can be opened up to receive a fishing line; and

FIG. 6 shows: a closer view of the ends of a fishing apparatus as shown in FIG. 5.

### DETAILED DESCRIPTION OF EMBODIMENTS OF THE INVENTION

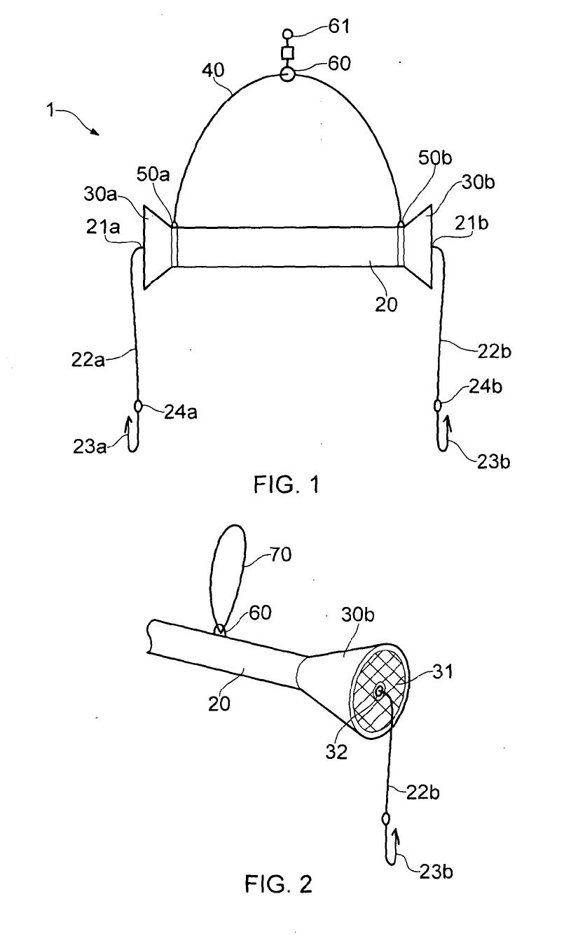

A fishing apparatus is shown generally as 1 in FIG. 1. The fishing apparatus includes a body 20 and at respective ends of the body there are openings at the end of the body 21a and 21b. From each of the openings there extends along a length of line 22a and 22b. The lengths may be individual lengths of line that are joined together with the join being within the body or they may be the ends of a single line that passes through the body. The body may include an insert (shown in FIG. 2) that supports the line and allows it to run freely in the body. The support can also act as a baffle to prevent noise and/or vibration that could occur as the line runs through the body 20.

There are first and second hooks 23a and 23b attached by connectors 24a and 24b to the lengths 22a and 22b. The connectors are attached such that beyond a certain strain they will break so that not all of the fishing apparatus is lost.

At either end of the body 20 there are receiving members 30a and 30b which are shown as being conical in the figures but they may be any shape which is large enough to receive a hook 23a or 23b. It is preferred however that the outer diameter of the receiving member is larger than the diameter of the body so providing a flared shape. Although ends having a flared shape are shown the ends may be of any shape that can receive a hook.

There is a further length of line 40 each end of which is attached to the body 20 by connectors 50a and 50b which are in proximity to receiving members 30a and 30b. The further length of line in turn is attached to a swivel loop 60 which if formed of a larger eye connected to a smaller eye 61. The smaller eye 61 is how the fishing apparatus can be attached to a main fishing line (not shown). The line 40 may be of a dimension that when a strain is exerted on it beyond a certain point the line 40 snaps so that the line on the rod itself is not lost. The lines 22a and 22b are of a lesser breaking strain than line 40 and the main fishing line that is attached to eye 61 so that if there is a strain put on the fishing apparatus lines 22a and 22b break first so acting as a sacrificial part of the apparatus which avoids all of the tackle being lost.

FIG. 2 shows a perspective view of a fishing apparatus with body 20 and receiving member 30b. The receiving member has an insert 31 which typically is a foam body that is push fitted in the receiving member. The insert has an aperture 32 through with line 22b extends. If the line is pulled from the other end the hook 23b that is on the end of the line is pulled towards the insert 31 and embeds itself in the foam insert and is retained there. This means that the hook and in particular the barbed end of the hook will not damage any fish that are hooked on the line by way of the other hook 23a and also if a fisherman draws in the line and starts to remove a hooked fish, he or she is at less risk of hurting themselves on a second hook because it is retained in the receiving member rather than being exposed.

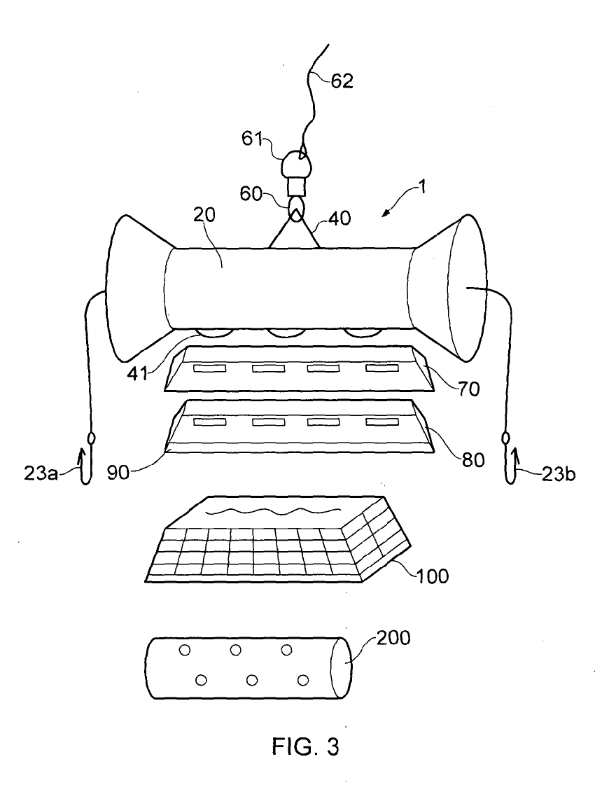

As shown in FIG. 3, the fishing apparatus 1 can have various attachments releasably secured to it. In particular it can be attached to a weight 70 which assists the body 20 in sinking to a required depth or to the bottom of a volume of water. The weight 70 may be a single weight or a plurality of weights that can be releasably secured to the body 20. In addition to or instead of a weight, a feeding device 80, 100 or 200 can be attached to the body. This may be in the form of a closed end feeder 80 which may have a weight 90 attached to the feeder. Alternatively a cage feeder 100 may be secured to the body or an open ended feeder 200 which typically is an elongate body having a series of apertures which expose feed to fish visiting the feeder. The feeder is positioned between the two ends of the body so that fish will be attracted roughly equally to the vicinity of the hooks 23a and 23b at each end of the body 20. The various attachments such as feeders can be secured to the main body by releasable clips to allow for ease of release and replacement.

As shown in FIG. 3, the line 40 may be positioned so it is secured along the whole length of the body 20, rather than just towards the two ends of the body as shown in previous figures; this allows for some of the line 41 to be exposed along the length of the feeder and as there is some line free this provides an attachment for the feeder to be secured to the body at any one or more of a number of locations along the body 20.

Although the figures show an elongate body 20, the body may be of other shapes such as rounded, square or of an irregular shape so it can resemble a rock or plant life that would be found in bodies of water such as a river, lake or pond. However whatever the shape there will be openings and receiving members such that if one hook is pulled by a baited fish, the other hook can be pulled within part of the body 20 so that the fish is not injured or damaged by the other hook. Furthermore although two hooks have been described it is possible to have a plurality of a Pair of hooks either within a single body or there may be a number of bodies having two hooks that are secured together. However the ideal is two hooks so that any fish that is caught is not damaged by a hook as once a fish is caught, any exposed hooks are pulled into the body to avoid damaging the fish.

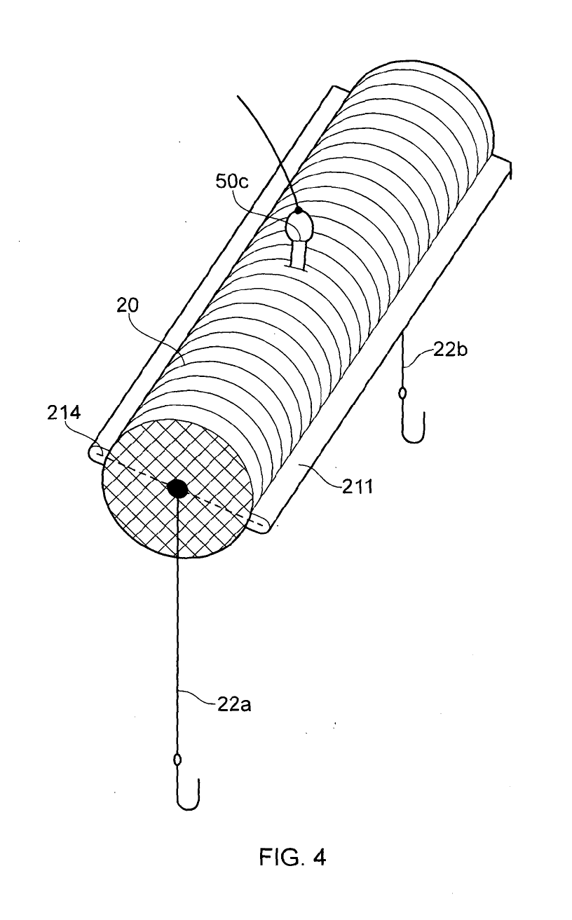

FIG. 4 shows an alternative way of securing the body 20 to a line. Rather than having the connectors at toward the end of the body as shown in FIG. 1, there is a single connector 50c which located in a central region of the body. The single connector makes it easy to attach and release a line. As shown the body 20 in this case is made of two parts which are hinged together by hinge 214 and which can be secured by a catch 211. This means that to secure the fish line having ends 22a and 22b in the body 20, the body is opened up and the line is placed between the two parts of the body and closed shut using the catch 211 and this holds the line in position.

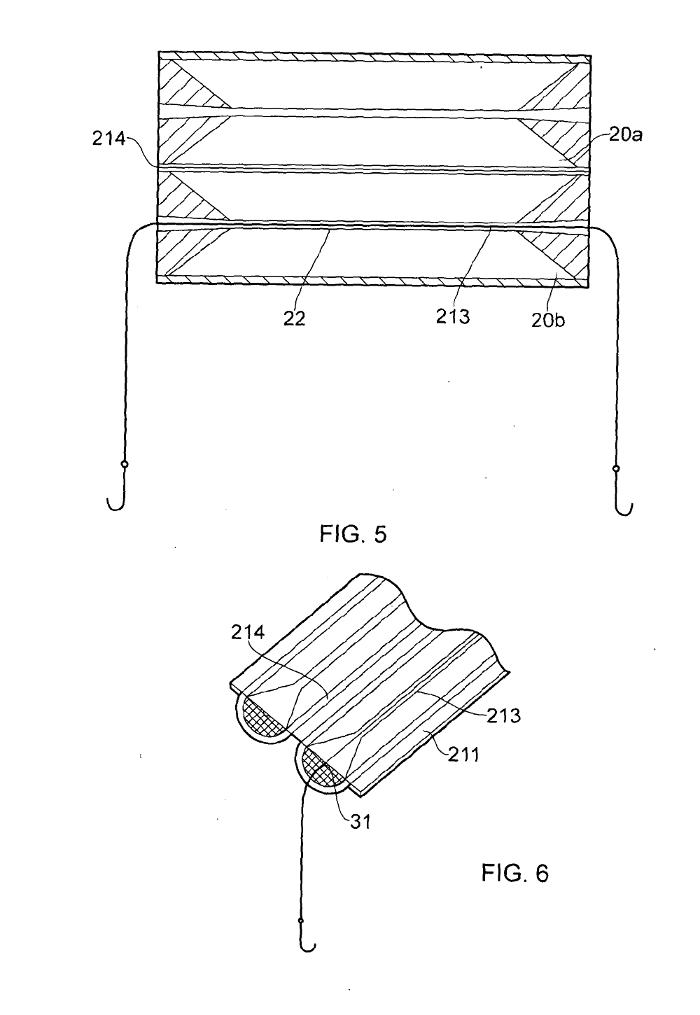

The opened up body is more apparent from FIG. 5. The body is formed of two parts 20a and 20b and at least one part has a channel 213. Preferably both parts 20a and 20b of the body have half channels which when the body is closed meet and enclose the fishing wire. The two parts are hinged together by hinge 214.

As shown in FIG. 6, the fishing wire passes along channel 213 and extends out of the end of the body where there are inserts 31 that are positioned in the receiving member at the end of the body and which holds the line at the end of the body. The body is closed by folding the two halves of the body towards each other by way of hinge member 214 and the two parts are held together using catch 211.

From the foregoing description, it should be appreciated that fishing apparatus according to the invention offers benefits to those fishing from locations such as a shoreline, pier, bridge or boat. With the protection against snags and damage to the fish that are afforded by the fishing apparatus of the present invention, the damage to fish, and the risk of the loss of tackle and time is minimized and the opportunities to catch fish are maximized. Further the device can be made from biodegradable material so that if any tackle is lost, it will not pollute the environment.

It should be noted that the above mentioned embodiments illustrate rather than limit the invention and that alteration or modifications are possible without departing from the scope of the invention as described and claimed. It is also to be noted that the invention covers not only individual embodiments but also combinations of any of the embodiments described.

What is claimed:

1. A fishing apparatus having a body with at least one bore with a fishing line running through said at least one bore, the fishing line having a first length to which a first hook is attached towards an end of the said first length and a second length to which a second hook is attached towards an end of said second length, characterized in that the first and second lengths extend from the body at first and second locations and said first and second locations are in proximity to first and second receiving members such that if a force is applied to the first hook, the second hook can be drawn into the second receiving member and if a force is applied to the second hook the first hook can be drawn into the first receiving member.

2. A fishing apparatus according to claim 1, wherein the body is an elongate tube.

3. A fishing apparatus according to claim 1, wherein the tube has flared ends which provide the first and second receiving members.

4. A fishing apparatus according to claim 1, wherein the receiving members are integral with the body.

5. A fishing apparatus according to claim 1, wherein the receiving members are separate members that can be releasable attached to the body.

6. A fishing apparatus according to claim 5, wherein the receiving members are inserts that can be push fitted into first and second locations of the body.

7. A fishing apparatus according to claim 1, wherein each receiving member includes a foam insert into which a hook can become embedded when it is drawn through the body.

8. A fishing apparatus according to claim 1, wherein the body has anchor points to which a main fishing line can be attached to the body of the fishing apparatus.

9. A fishing apparatus according to claim 1, wherein the body has securing members to which a feeder or weight can be releasably secured.

10. A fishing apparatus according to claim 1, wherein the body has attachment means to enable one body to be releasably secured to another body.

11. A fishing apparatus according to claim 1, wherein the body has a plurality of bores each with a line having a hook secured to either end of said line.

12. A fishing apparatus according to claim 1, wherein the body of the fishing body is formed of two parts hinged together wherein said two parts can be brought towards one another thereby enclosing at least part of a fishing line positioned between said two parts with the first and second lengths of the fishing line extending form ends of the body.

13. A fishing apparatus according to claim 12, wherein the two parts when closed are secured to one another by a releasable catch that can be opened to retrieve or introduce fishing line into the body.

14. A fishing apparatus according to claim 1, which is made from biodegradable material.

15. A fishing apparatus according to claim 1, wherein fishing tackle including a rod and main line are attached.

16. (canceled)
